(19) United States
(12) Patent Application Publication
(10) Pub. No.: US 2004/0151431 A1
(43) Pub. Date: Aug. 5, 2004

(54) Lensed fiber having small form factor and method of making the same

(76) Inventor: Ljerka Ukrainczyk, Painted Post, NY (US)

Correspondence Address: CORNING INCORPORATED, SP-TI-3-1, CORNING, NY, 14831

(21) Appl. No.: 10/762,868

(22) Filed: Jan. 20, 2004

Related U.S. Application Data
(60) Provisional application No. 60/442,150, filed on Jan. 23, 2003.

(51) Int. Cl. G02B 6/32

(52) U.S. Cl. 385/33; 385/34

(57) ABSTRACT

A lensed fiber includes an optical fiber and a lens formed at a distal end of the optical fiber. The lens has a minimum diameter determined by 2·T·tan(θ), where θ=n·sin⁻¹(NA), T is thickness of the lens, n is index of refraction of the lens, and NA is numerical aperture of the optical fiber.

### CROSS-REFERENCE TO RELATED APPLICATIONS

This application claims the benefit of U.S. Provisional Application Ser. No. 60/442,150, filed Jan. 23, 2003, entitled “Lensed fiber having small form factor and method of making the same.”

### BACKGROUND OF INVENTION

The invention relates generally to methods and devices for coupling light between optical fibers and optical devices in optical communication networks. In particular, the invention relates to lensed fibers for focusing or collimating beams and to a method of making the lensed fibers.

Light emerges from the end of an optical fiber in the form of a diverging beam. In collimating applications, a lens is used to convert this diverging beam to a substantially parallel beam. If the light is subsequently to be re-launched into another optical fiber, another lens operating in the reverse sense will be needed. In focusing and condenser applications, a lens is used to convert the diverging beam to a slightly converging beam. In general, the lens must be properly coupled to the optical fiber to achieve efficient conversion of the diverging beam to either a substantially parallel beam or a slightly converging beam. One method for coupling the lens to the optical fiber is based on a fusion process. In this method, a planoconvex lens is fusion-spliced to an optical fiber to form a monolithic device called a lensed fiber.

Lensed fibers are advantageous because they do not require active fiber-to-lens alignment and/or bonding of fiber to lens, they have low insertion loss, and they enable device miniaturization and design flexibility. Lensed fibers are easily arrayed and are therefore desirable for making arrayed devices, such as variable optical attenuators and optical isolators, for use in silicon optical bench applications, for use as high power connectors and dissimilar fiber connectors, and for coupling optical signals into other micro-optic devices. The beam emerging from the lensed fiber typically has a perfect Gaussian profile. Further, the beam diameter and working distance can be can be tailored to application specifications.

FIG. 1A shows a prior-art lensed fiber 100 having a planoconvex lens 102 fusion-spliced to an optical fiber 104. The lens 102 has a convex surface 106. The radius of curvature (Rc) of the convex surface 106 and the thickness (T) of the lens 102 depend on the desired optical characteristics. In FIG. 1A, the convex surface 106 has a large radius, e.g., much greater than 60 μm. FIG. 1B shows a lens geometry wherein the convex surface 106 has a small radius of curvature. In the prior-art lensed fibers shown in FIGS. 1A and 1B, the overall diameter of the lens 102 is twice the radius of curvature of the convex surface 106. In general, the larger the radius of curvature, the wider the range of beam diameters and working distances possible and the higher the flexibility in tailoring the lensed fiber to meet application specifications. On the other hand, the larger the radius of curvature, the larger the overall diameter of the lensed fiber. Large lensed fibers would result in larger devices and an increase in material and packaging cost.

From the foregoing, there is desired a lensed fiber having a small form factor and a wide range of beam diameters and working distances.

### SUMMARY OF INVENTION

In one aspect, the invention relates to a lensed fiber which comprises an optical fiber and a lens formed at a distal end of the optical fiber. The lens has a minimum diameter determined by 2·T·tan(θ), where θ=n·sin⁻¹ (NA), T is thickness of the lens, n is index of refraction of the lens, and NA is numerical aperture of the optical fiber.

In another aspect, the invention relates to a method of making a lensed fiber having an optical fiber and a lens. The method comprises splicing an optical fiber to a coreless fiber, reducing the coreless fiber to a desired length based on a desired thickness of the lens, and laser machining a predetermined radius of curvature at a distal end of the coreless fiber.

In another aspect, the invention relates to a method of making a lensed fiber having an optical fiber and a lens which comprises splicing an optical fiber to a coreless fiber having a minimum diameter determined by 2·T·tan(θ), where θ=n·sin⁻¹(NA), T is thickness of the lens, n is index of refraction of the lens, and NA is numerical aperture of the optical fiber. The method further includes reducing the coreless fiber to a desired length based on the thickness of the lens and forming a predetermined radius of curvature at a distal end of the coreless fiber.

Other features and advantages of the invention will be apparent from the following description and the appended claims.

### BRIEF DESCRIPTION OF DRAWINGS

FIG. 1A shows a prior-art lensed fiber having a lens with a large radius of curvature and a diameter equal to twice the radius of curvature.

FIG. 1B shows a prior-art lensed fiber having a lens with a small radius of curvature and a diameter equal to twice the radius of curvature.

FIG. 2 shows a lensed fiber according to one embodiment of the invention.

FIG. 3A illustrates an alignment step of a method for making a lensed fiber according to one embodiment of the invention.

FIG. 3B illustrates a fusion-splicing step of a method for making a lensed fiber according to one embodiment of the invention.

FIG. 3C shows the lensed fiber of FIG. 3B after a cleaving step according to one embodiment of the invention.

FIG. 3D shows the lensed fiber of FIG. 3C after a curvature formation step according to one embodiment of the invention.

FIG. 4A shows a relationship between mode field diameter and lens geometry for a planoconvex lens formed from a glass with refractive index of 1.444 at wavelength of 1550 nm and spliced to a single-mode fiber with mode field radius at splice of 6 μm.

FIG. 4B shows a relationship between distance to beam waist and lens geometry for a planoconvex lens formed from a glass with refractive index of 1.444 at wavelength of 1550 nm and spliced to a single-mode fiber with mode field radius at splice of 6 μm.

### DETAILED DESCRIPTION OF THE PREFERRED EMBODIMENTS

The invention will now be described in detail with reference to a few preferred embodiments, as illustrated in accompanying drawings. In the following description, numerous specific details are set forth in order to provide a thorough understanding of the invention. It will be apparent, however, to one skilled in the art that the invention may be practiced without some or all of these specific details. In other instances, well-known process steps and/or features have not been described in detail in order to not unnecessarily obscure the invention. The features and advantages of the invention may be better understood with reference to the drawings and discussions that follow.

For illustration purposes, FIG. 2 shows a lensed fiber 200 according to an embodiment of the invention. The lensed fiber 200 includes a planoconvex lens 202 attached to, or formed at, an end of an optical fiber 204. Typically, the lens 202 is attached to the optical fiber 204 by a fusion-splicing process, though an index-matched epoxy or other attachment can also be used, but with reduced reliability. In one embodiment, the optical fiber 204 is a stripped region of a coated optical fiber (or pigtail) 205. The optical fiber 204 has a core 206 and may or may not have a cladding 208 surrounding the core 206, i.e., the cladding 208 could be air. The optical fiber 204 could be any single-mode fiber, including a polarization-maintaining (PM) fiber, a multimode fiber, or other specialized fiber. In operation, a light beam traveling down the core 206 diverges upon entering the lens 202 and is refracted into a collimated or focused beam upon exiting the lens 202.

The lens 202 has a convex surface 210 with a radius of curvature (Rc). Unlike the prior-art lenses discussed in the background section, the overall diameter of the lens 202 is not coupled to the radius of curvature of the convex surface 210. Instead, the minimum diameter of the lens 202 is determined by the size of the beam at the apex 212 of the lens 202. The minimum diameter (Dₘᵢₙ) can be calculated using the following expression:

Dₘᵢₙ=2·T·tan(θ) (1)

where

θ=n·a sin(NA) (2)

where T is the thickness of the lens 202, n is index of refraction of the lens 202, and NA is the numerical aperture of the optical fiber 204.

The maximum thickness of the lens 202 is determined by clipping of the beam at the apex of the lens:

$${T}_{max} = \frac{D}{π \cdot tan ( \frac{λ}{π \cdot {w}_{o}} )} \qquad ( 3 )$$

where D is diameter of the lens, λ is wavelength in the lens material, and wₒ is the mode field radius of the optical fiber 204 at the splice to the lens 202.

Decoupling the overall diameter of the lens 202 from the radius of curvature of the convex surface 210 makes it possible to make a lensed fiber with a wide range of mode field diameters and working distances while keeping the size of the lensed fiber small. To obtain a Gaussian beam profile, the radius of curvature of the convex surface 210 should not be smaller than the mode field radius (measured at 99% clip level) of the mode in the lensed fiber. If the mode field radius measured at 99% clip level at the apex of the lens is larger than the radius of curvature, the beam will be clipped, resulting in power loss, beam distortion from optimal Gaussian shape, and less efficient coupling. There is no upper limit on radius of curvature of the convex surface 210.

An example of the size advantage is illustrated by an example of a lensed fiber with a mode field diameter of 220 μm and distance to beam waist of 10 mm at a wavelength of 1550 nm, using a single-mode optical fiber with approximately 5.5 μm core radius and a lens having a refractive index of 1.444 (at 1550 nm), a thickness of 1.946 mm, and a radius of curvature of 0.6 mm. The minimum diameter of the lens, as determined by equation (1) above, is 0.38 mm. A prior-art lens having a diameter equal to twice the radius of curvature would have a diameter of 1.2 mm, which is more than four times the minimum diameter determined using equation (1).

The lens 202 is made from a coreless fiber or rod that has transmission at the wavelength of interest. The diameter of the coreless fiber can be the same as, larger than, or smaller than the diameter of the optical fiber 204. Typically, the coreless fiber is made of silica or doped silica and has a refractive index that is similar to the refractive index of the core 206. The coefficient of thermal expansion of the lens 202 can be matched to that of the optical fiber 204 to achieve better performance over a temperature range. The lens 202 may be coated with an anti-reflection coating to minimize back-reflection. A back-reflection less than −55 dB is generally desirable. When the lens 202 is made according to the expression given in equation (1), the diameter of the lens 202 can be very small, i.e., much smaller than twice the radius of curvature, while the radius of curvature can be quite large, e.g., in a range from 50 to 5,000 μm. This enables component miniaturization, especially for arrayed devices, and provides high flexibility in tailoring mode field diameter and working distance for a specific application.

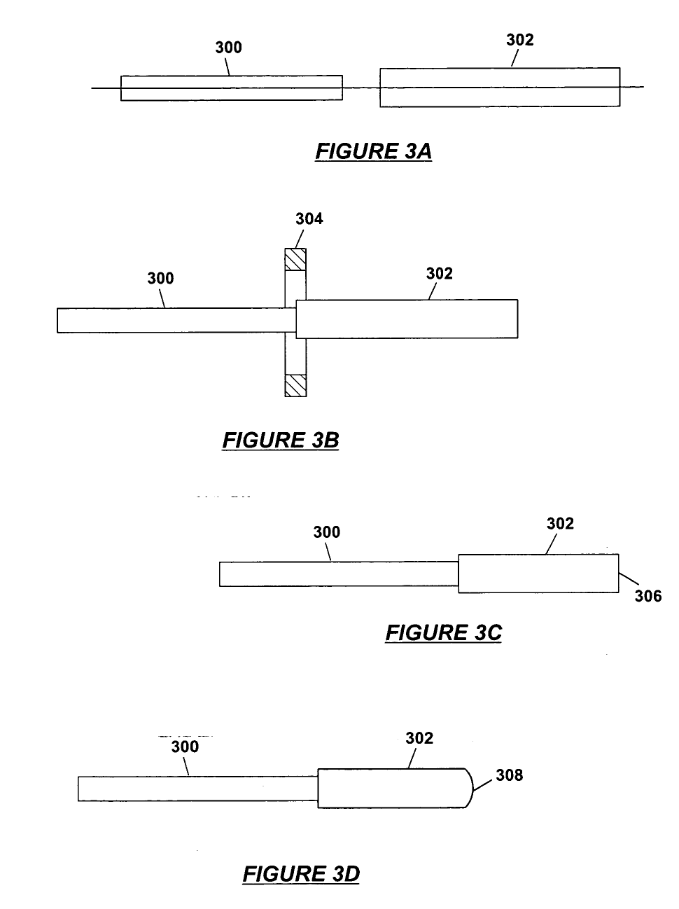

A method of making a lensed fiber, such as described in FIG. 2, will now be described with reference to FIGS. 3A-3D. In FIG. 3A, the method starts with aligning the axial axis of an optical fiber 300 with an axial axis of a coreless fiber or rod 302. The diameter of the coreless fiber 302 can be the same as, smaller than, or larger than the diameter of the optical fiber. The minimum diameter of the coreless fiber 302 is given by equation (1) above. After aligning the axes of the optical fiber 300 and the coreless fiber 302, the opposing ends of the optical fiber 300 and coreless fiber 302 are brought together, as shown in FIG. 3B, and are fusion-spliced together using a heat source 304. The heat source 304 may be a resistive filament or other suitable heat source, such as an electric arc or laser.

After splicing the coreless fiber 302 to the optical fiber 300, the coreless fiber 302 is cleaved to the desired length or lens thickness, as shown in FIG. 3C. Cleaving of the coreless fiber 302 can be achieved by, e.g., laser machining, mechanical cleaver, or other suitable device. Instead of cleaving the coreless fiber 302, the coreless fiber 302 could also be taper-cut by applying heat to the coreless fiber 302 while pulling the fibers 300, 302 in opposing directions. The next step is to form a desired curvature at the distal (or cleaved) end 306 of the coreless fiber 302. In FIG. 3D, a curvature 308 is formed at the distal end of the coreless fiber 302. The curvature 308 can be formed using, for example, laser machining or mechanical polishing.

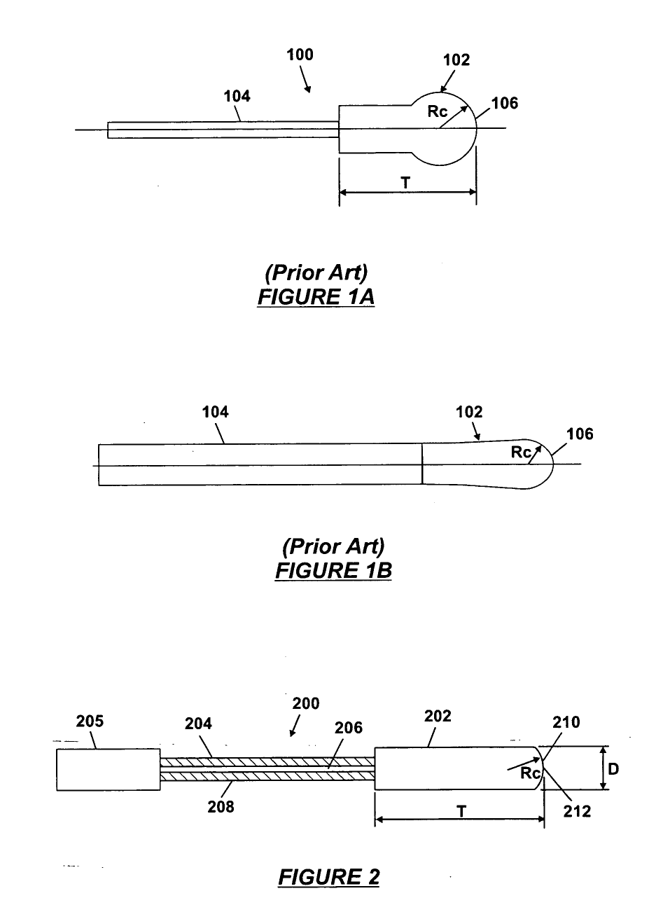

It is also possible, but cumbersome, to first form a lensed fiber as shown in FIG. 1A with the desired lens thickness and radius of curvature and then machine or polish off material from the lensed fiber to reduce the overall diameter of the lensed fiber to the desired diameter.

The following example is intended for illustration only and is not to be construed as limiting the invention as otherwise described herein.

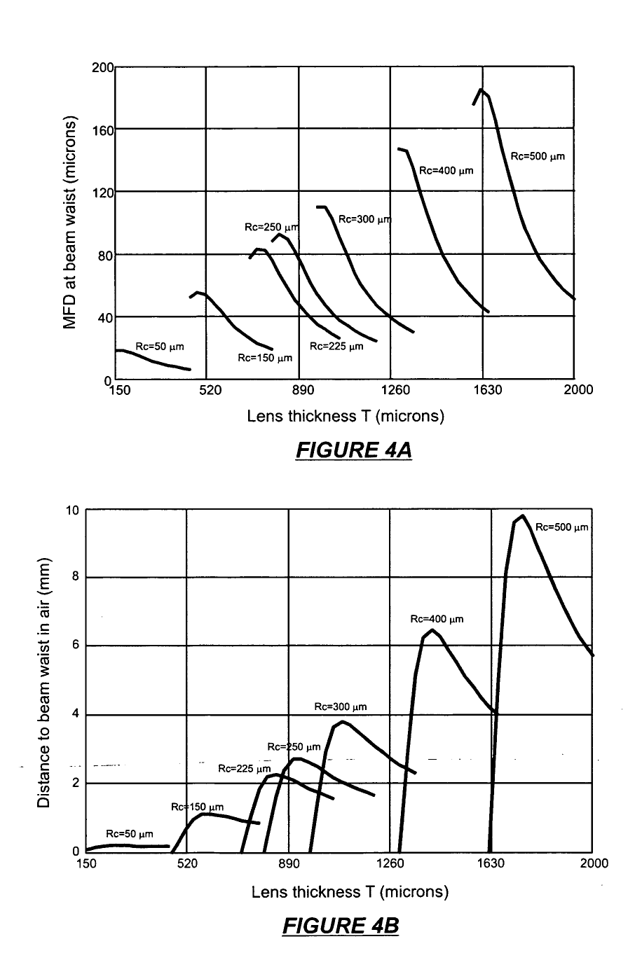

FIG. 4A shows mode field diameter at beam waist as a function of lens thickness and radius of curvature for a lensed fiber having a single-mode fiber with mode field radius of 6 μm spliced to a planoconvex lens made from a coreless glass fiber having a refractive index of 1.444 at a wavelength of 1550 nm. FIG. 4B shows distance to beam waist in air as a function of lens thickness and radius of curvature for the lensed fiber previously described. In the present invention, the wide range of mode field diameters, distances to beam waist, and radii of curvatures are achieved while maintaining the small form factor of the lensed fiber and without sacrificing performance.

The invention provides one or more advantages. One advantage is that a lens with a large mode field diameter and working distance can be made while keeping the size of the lensed fiber small. As an example, the radius of curvature of the lens can range from 50 to 5,000 μm, the lens thickness can range from 15 to 18,000 μm, the distance to beam waist in air of the lens can range from 0 to 100 mm, and the mode field diameter at the beam waist can range from 3 to 1000 μm, while keeping the overall diameter of the lensed fiber substantially the same. This is advantageous because devices incorporating such a lensed fiber can be kept small. The diameter of the lens can be selected such that the lensed fiber can be packaged in standard glass or ceramic fiber ferrule or into V-grooves or other etched structures on silicon chips or other semiconductor platforms. For arrayed applications, the lensed fiber with the small form factor also enables dense arrays.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A lensed fiber, comprising:
an optical fiber; and
a lens formed at a distal end of the optical fiber, the lens having a minimum diameter determined by 2·T·tan(θ), where θ=n·sin⁻¹(NA), T is thickness of the lens, n is index of refraction of the lens, and NA is numerical aperture of the optical fiber.

2. The lensed fiber of claim 1, wherein a radius of curvature of the lens is not smaller than a mode field radius of a mode in the lensed fiber at an apex of the lens.

3. The lensed fiber of claim 1, wherein a radius of curvature of the lens is in a range from approximately 50 to 5,000 μm.

4. The lensed fiber of claim 3, wherein a thickness of the lens is in a range from approximately 15 to 18,000 μm.

5. The lensed fiber of claim 3, wherein a distance to beam waist in air of the lens is in a range from approximately 0 to 100 mm.

6. The lensed fiber of claim 3, wherein a mode field diameter at beam waist of the lens is in a range from approximately 3 to 1,000 μm.

7. A method of making a lensed fiber having an optical fiber and a lens, comprising:
splicing an optical fiber to a coreless fiber;
reducing the coreless fiber to a desired length based on a desired thickness of the lens; and
laser machining a predetermined radius of curvature at a distal end of the coreless fiber.

8. The method of claim 7, wherein the coreless fiber has a minimum diameter determined by 2·T·tan(θ), where θ=n·sin⁻¹(NA), T is the desired thickness of the lens, n is index of refraction of the lens, and NA is numerical aperture of the optical fiber.

9. The method of claim 7, wherein reducing the coreless fiber to the desired length comprises cleaving the coreless fiber to the desired length.

10. The method of claim 7, wherein reducing the coreless fiber to the desired length comprises taper-cutting the coreless fiber to the desired length.

11. The method of claim 7, wherein the desired length of the coreless fiber is at least equal to the desired thickness of the lens.

12. The method of claim 7, wherein the desired length of the coreless fiber is greater than the desired thickness of the lens.

13. The method of claim 12, wherein laser machining the predetermined radius of curvature comprises reducing the desired length of the coreless fiber to the desired thickness of the lens.

14. A method of making a lensed fiber having an optical fiber and a lens, comprising:
splicing an optical fiber to a coreless fiber having a minimum diameter determined by
2·T·tan(θ), where θ=n·sin⁻¹ (NA), T is thickness of the lens, n is index of
refraction of the lens, and NA is numerical aperture of the optical fiber;
reducing the coreless fiber to a desired length based on the thickness of the lens; and
forming a predetermined radius of curvature at a distal end of the coreless fiber.
